(19) United States
(12) Patent Application Publication
(10) Pub. No.: US 2018/0251394 A1
(43) Pub. Date: Sep. 6, 2018

(54) METHOD AND SYSTEM FOR REDUCING AGGLOMERATES IN A GLASS MELT

(71) Applicant: CORNING INCORPORATED, CORNING, NY (US)

(72) Inventors: Sean Steven Frink, Danville, KY (US); Kimberly Errin Hill, Lindley, NY (US); Katherine Rose Rossington, Corning, NY (US); Navin Venugopal, Horseheads, NY (US)

(21) Appl. No.: 15/559,696

(22) PCT Filed: Mar. 17, 2016
(86) PCT No.: PCT/US2016/022789

§ 371 Date: Sep. 19, 2017

Related U.S. Application Data
(60) Provisional application No. 62/136,034, filed on Mar. 20, 2015.
(60) Provisional application No. 62/141,410, filed on Apr. 1, 2015.

(51) Int. Cl. C03C 1/02; C04B 35/468; C01G 23/00; C04B 35/626; C04B 35/632; C09C 1/36; C03C 3/087

(52) U.S. Cl. CPC C03C 1/02; C04B 35/468; C01G 23/006; C03C 3/087; C04B 35/632; C09C 1/3669; C04B 35/6264

(57) ABSTRACT

Disclosed herein are methods for making glass, comprising forming a slurry comprising at least one fining agent; adjusting the pH of the slurry to a value ranging from about 3 to about 12; combining the slurry with glass batch materials to form a batch composition; and melting the batch composition. Methods for reducing agglomerates in a glass melt are also disclosed herein. Further disclosed herein are systems for making glass, the systems comprising a pre-mixing vessel for preparing a slurry comprising at least one fining agent; an ultrasonic vessel for applying ultrasonic energy to the slurry; a mixing vessel for combining the slurry with glass batch materials to form a batch composition; and a melting vessel for melting the batch composition.

### CROSS-REFERENCE TO RELATED APPLICATIONS

This application claims the benefit of priority under 35 U.S.C. § 119 of U.S. Provisional Application Ser. No. 62/141,410 filed on Apr. 1, 2015, which in turn, claims the benefit of priority of U.S. Provisional Application Ser. No. 62/136,034 filed on Mar. 20, 2015, the contents of each of which are relied upon and incorporated herein by reference in their entireties.

### FIELD OF THE DISCLOSURE

The present disclosure relates generally to methods and systems for processing glass batch materials, and more particularly to methods and systems for reducing agglomerates in a glass melt.

### BACKGROUND

Glass substrates may be used in a variety of applications, ranging from windows to high-performance display devices. The quality requirements for glass substrates have become more stringent as the demand for improved resolution, clarity, and performance increases. Glass quality may, however, be negatively impacted by various processing steps, from forming the glass melt to final packaging of the glass product. In particular, glass sheet quality may be negatively impacted by the presence of imperfections or bubbles, and in some cases even a single imperfection in the glass sheet can render it unsuitable for its intended use.

During the melting process, glass precursor batch materials can be mixed together and heated in a melting vessel. The batch materials melt and react, giving off reaction gases, which may produce bubbles in the molten glass. The molten glass can then undergo a fining step to remove gas bubbles trapped in the melt. Fining can promote bubble removal via two processes. Stokes fining occurs when an increase in the glass temperature leads to a lower viscosity of the glass melt. Bubbles can then rise more rapidly through the less viscous glass melt. Chemical fining occurs when an increase in the glass temperature chemically reduces a chemical fining agent, thus releasing oxygen into the glass, which can then be incorporated into the bubbles. As the bubbles take up excess oxygen they increase in size and rise through the glass melt more easily, sometimes merging with other bubbles and/or collapsing.

Fining agents can include tin, arsenic, and antimony, to name a few. Arsenic and antimony are stronger fining agents but may pose safety and environmental hazards and, thus, are less frequently used. Tin dioxide is relatively safer, but also has relatively weaker fining power. Moreover, the amount of tin that can be incorporated as a fining agent into the glass batch materials is often limited because elevated levels of tin can lead to the formation of secondary crystals or agglomerates during downstream processing (e.g., on the vessels, pipes, and/or forming body).

Tin oxide agglomerate (TOA) defects in glass products can result from the agglomeration of SnO₂ raw material that remains unmelted in the glass melt. The SnO₂ particle size distribution can be very fine (e.g., about 1-10 microns), which can make it more prone to clumping and electrostatic attraction. TOAs can thus create stream defects that may impact overall equipment efficiency (OEE), which can manifest as low level loss to the OEE or as an equipment outage that can range from hours to days offline.

Conventional methods for preventing TOA formation include different mechanical methods for mixing the glass batch materials or pre-mixing the SnO₂ raw materials with other materials (e.g., sand). Other conventional methods include coating the SnO₂ with silica or alumina powder or liquid addition of SnO₂ to the glass melt by liquid injection of sodium or potassium stannate. However, these methods still suffer from one or more drawbacks including increased cost and/or complexity. Additionally, the liquid addition of SnO₂ may introduce large amounts of water into the glass melt due to low SnO₂ concentration in the liquid (e.g., less than 12% by weight SnO₂). Excess moisture in the glass melt can create a higher risk for defects and/or can facilitate the formation of clumps in the raw glass batch materials. Accordingly, it would be advantageous to provide glass fining and manufacturing processes which have lower cost and/or complexity, while also minimizing negative impacts on equipment efficiency due to agglomerates, and minimizing issues relating to glass quality, such as defects caused by bubbles or agglomerates in the melt.

### SUMMARY

The disclosure relates, in various embodiments, to methods for making glass, the methods comprising forming a slurry comprising at least 15% by weight of at least one fining agent; adjusting the pH of the slurry to a value ranging from about 3 to about 12; combining the slurry with glass batch materials to form a batch composition; and melting the batch composition. Also disclosed herein are methods for reducing agglomerates in a glass melt, the methods comprising forming a slurry comprising at least one fining agent having an average particle size of less than or equal to about 10 microns; adjusting the pH of the slurry to a value ranging from about 3 to about 12; combining the slurry with glass batch materials to form a batch composition; and melting the batch composition. Further disclosed herein are methods for making glass, the methods comprising combining a slurry comprising at least one fining agent with glass batch materials to form a batch composition and melting the batch composition, wherein the slurry has a pH ranging from about 3 to about 12 and a zeta potential ranging from about +5 mV to about +60 mV or from about −5 mV to about −60 mV. Still further disclosed herein are systems for making glass, the systems comprising a pre-mixing vessel for preparing a slurry comprising at least one fining agent; an ultrasonic vessel for applying ultrasonic energy to the slurry; a mixing vessel for combining the slurry with glass batch materials to form a batch composition; and a melting vessel for melting the batch composition.

Additional features and advantages will be set forth in the detailed description which follows, and in part will be readily apparent to those skilled in the art from that description or recognized by practicing the invention as described herein, including the detailed description which follows, the claims, as well as the appended drawings.

It is to be understood that both the foregoing general description and the following detailed description present various embodiments, and are intended to provide an overview or framework for understanding the nature and character of the invention as it is claimed. The accompanying drawings are included to provide a further understanding, and are incorporated into and constitute a part of this specification. The drawings illustrate various embodiments and together with the description serve to explain the principles and operations of the invention.

### BRIEF DESCRIPTION OF THE DRAWINGS

The following detailed description can be best understood when read in conjunction with the following drawings, where like structures are indicated with like reference numerals and in which:

FIG. 1 is a graphical depiction of the zeta potential of SnO₂ particles as a function of pH;

FIG. 2 depicts a schematic of a glass manufacturing system according to certain embodiment of the disclosure;

FIG. 3 depicts a schematic of a pre-mixing system according to various embodiments of the disclosure;

FIG. 4 is a graphical depiction of particle size for slurries according to certain embodiments of the disclosure; and

FIGS. 5A-D are images of exemplary glass melts according to various embodiments of the disclosure.

### DETAILED DESCRIPTION

Methods

Disclosed herein are methods for making glass, the methods comprising forming a slurry comprising at least 15% by weight of SnO₂; adjusting the pH of the slurry to a value ranging from about 3 to about 12; combining the slurry with glass batch materials to form a batch composition; and melting the batch composition. Methods for reducing agglomerates in a glass melt are also disclosed herein, the methods comprising forming a slurry comprising at least one fining agent having an average particle size of less than or equal to about 10 microns; adjusting the pH of the slurry to a value ranging from about 3 to about 12; combining the slurry with glass batch materials to form a batch composition; and melting the batch composition. Further disclosed herein are methods for making glass, the methods comprising combining a slurry comprising at least one fining agent with glass batch materials to form a batch composition and melting the batch composition, wherein the slurry has a pH ranging from about 3 to about 12 and a zeta potential ranging from about +5 mV to about +60 mV or from about −5 mV to about −60 mV.

The method disclosed herein can comprise a step of forming a slurry comprising at least one fining agent, such as SnO₂ (tin dioxide). For example, the slurry can comprise from about 15% to about 50% by weight of at least one fining agent (e.g., SnO₂), such as from about 20% to about 45%, from about 25% to about 40%, or from about 30% to about 35% by weight, including all ranges and subranges therebetween. The slurry can further comprise at least one solvent, for example, water, isopropyl alcohol, butanol, glycol, aqueous-alcoholic mixtures, and combinations thereof. In some embodiments, the fining agent can be added to the solvent with agitation, e.g., mechanical stirring, to suspend the fining agent in the solvent. The fining agent can, in various embodiments, have an average particle size of less than or equal to about 10 microns, such as ranging from about 0.1 to about 10 microns, for example, about 0.5, 1, 2, 3, 4, 5, 6, 7, 8, or 9 microns, including all ranges and subranges therebetween. According to some embodiments, the fining agent can be SnO₂ having an average particle size ranging from about 2 microns to about 10 microns. In additional embodiments, the slurry can consist or consist essentially of at least one fining agent such as tin dioxide and at least one solvent.

The slurry can also comprise at least one fining agent in addition to or as an alternative to SnO₂, such as As₂O₃ or Sb₂O₃, to name a few. The fining agent can have, in some embodiments, an average particle size of about 10 microns or less, such as from about 1 micron to about 10 microns, e.g., about 2, 3, 4, 5, 6, 7, 8, or 9 microns, including all ranges and subranges therebetween. The fining agent can be present in the slurry in an amount less than or equal to about 50% by weight, such as less than about 45%, less than about 40%, less than about 35%, less than about 30%, less than about 25%, less than about 20%, less than about 15%, less than about 10%, or less than about 5% by weight, including all ranges and subranges therebetween. In various embodiments, the fining agent can be present in an amount ranging from about 15% to about 35% by weight. According to further embodiments, the slurry can optionally comprise at least one additive chosen, for instance, from surfactants and dispersants. For example, the slurry can comprise at least one additive chosen from ethylene oxide (EO) and propylene oxide (PO) polymers and copolymers, fatty acids, siloxanes, sodium meta phosphate, sodium stearate, calgon, naphthalene sulfonate, and the like, and combinations thereof.

The slurry can be formed by mixing the fining agent (e.g., SnO₂) with a solvent, e.g., using mechanical agitation. According to certain embodiments, the fining agent can be in the form of a powder, such as a fine oxide powder (e.g., having an average particle size of 10 microns or less). Mixing times can vary as necessary depending on various parameters, such as concentration, starting materials, and so forth. In additional embodiments, the mixing time can range from about 1 minute to about 12 hours, for example, from about 5 minutes to about 8 hours, from about 10 minutes to about 6 hours, from about 20 minutes to about 4 hours, from about 30 minutes to 3 hours, or from about 1 hour to about 2 hours, including all ranges and subranges therebetween.

The slurry can be treated with at least one buffer to modify the pH of the slurry as desired. For instance, the pH of the slurry can be adjusted to move away from its isoelectric point, thereby imparting a charge to the fining agent particles. The residual charge on the particle surface at the adjusted pH value can cause electrostatic repulsion to overcome van der Waals attractive forces between the particles. As used herein, the term “agglomerates” is used to refer to clusters of fining agent particles adhered or otherwise bonded together by such van der Waals forces. The agglomerates can have, for example, an average diameter ranging from about 5 microns to about 250 microns, such as from about 10 microns to about 200 microns, from about 20 microns to about 150 microns, from about 30 microns to about 100 microns, from about 40 microns to about 90 microns, from about 50 microns to about 80 microns, or from about 60 microns to about 70 microns, including all ranges and subranges therebetween.

The pH adjustment can be carried out, e.g., by the addition of either an acid or base as a buffer, causing the zeta potential to become increasingly positive or negative, respectively. For example, the slurry can be treated with an acidic buffer, such as an inorganic acid including hydrochloric acid, sulfuric acid, and nitric acid, to name a few, and carboxylic acids, such as acetic acid and propionic acid, as well as basic buffers, including sodium hydroxide, aqueous ammonia and organic amines (e.g., ethanolamine). The pH of the slurry can, for example, be adjusted to a value ranging from about 3 to about 12, such as from about 4 to about 11, from about 5 to about 10, from about 6 to about 9, or from about 7 to about 8, including all ranges and subranges therebetween. For instance, the pH of the slurry can be modified to a value ranging from about 3 to about 6 or from about 8 to about 12.

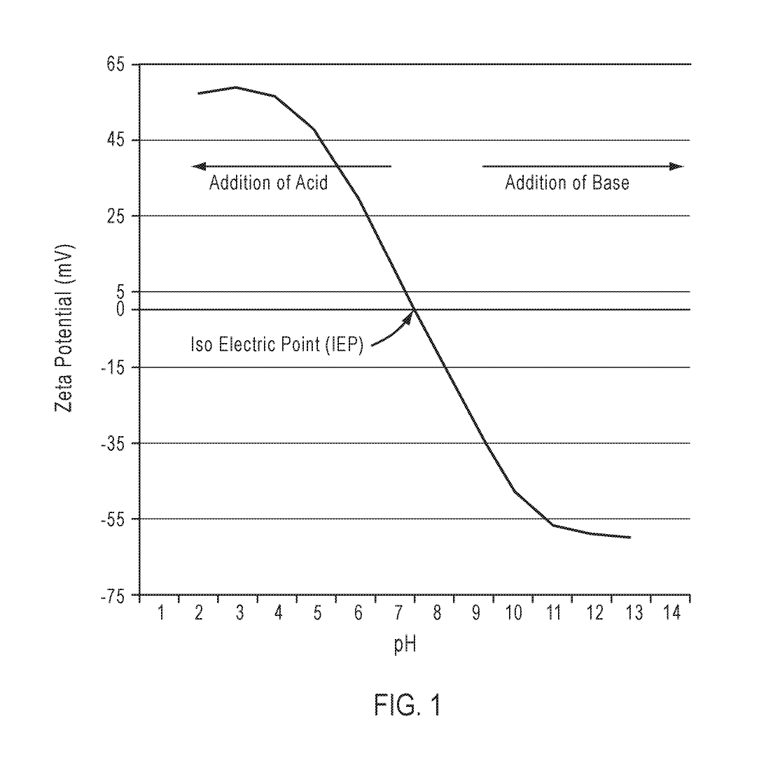

Referring to FIG. 1, which illustrates the zeta potential of SnO₂ particles as a function of pH, it was discovered and can be observed that the zeta potential (e.g., charge on the outer layer of each particle) can be made more positive (addition of acid) or more negative (addition of base). The stability of a suspension, slurry, and/or solution comprising SnO₂ can therefore be enhanced by minimizing and/or discouraging agglomeration of the SnO₂ particles by modifying the zeta potential. Strong positive or negative zeta potential can create a repulsive force between the individual particles thereby increasing the stability (e.g., increasing the absolute value of the surface potential). It was discovered that by moving the charge of the particles further away from their isoelectric point (e.g., where the particles have a neutral charge), it may be possible to decrease the propensity of the particles to agglomerate or coagulate. In certain embodiments, the slurry may be adjusted using an acid buffer to a positive zeta potential ranging from about +5 my to about +60 mV, such as from about +10 mV to about +55 mV, from about +15 mV to about +50 mV, from about +20 mV to about +45 mV, from about +25 mV to about +40 mV, or from about +30 mV to about +35 mV, including all ranges and subranges therebetween. According to further embodiments, the slurry may be adjusted using a base buffer to a negative zeta potential ranging from about −5 my to about −60 mV, such as from about −10 mV to about −55 mV, from about −15 mV to about −50 mV, from about −20 mV to about −45 mV, from about −25 mV to about −40 mV, or from about −30 mV to about −35 mV, including all ranges and subranges therebetween.

Ultrasonic energy can be applied to the slurry using any means known in the art. For example, one or more vibration generators may be used to provide sonic energy at ultrasonic frequencies, e.g., in the kHz range. Ultrasonic energy can have, for example, a frequency ranging from about 1 kHz to about 1000 kHz, such as from about 5 kHz to about 500 kHz, from about 10 kHz to about 250 kHz, or from about 50 kHz to about 100 kHz, including all ranges and subranges therebetween. Ultrasonic transducers may provide frequencies ranging, for example, from about 10 kHz to about 120 kHz, such as from about 15 kHz to about 100 kHz, from about 20 kHz to about 75 kHz, or from about 25 kHz to about 50 kHz.

In certain embodiments, the ultrasonic energy input may range from about 25 W·s/g to about 100 W·s/g, such as from about 35 W·s/g to about 70 W·s/g, from about 40 W·s/g to about 65 W·s/g, from about 45 W·s/g to about 60 W·s/g, or from about 50 W·s/g to about 55 W·s/g, including all ranges and subranges therebetween. According to various embodiments, the at least one buffer can be added before and/or after the slurry is exposed to ultrasonic energy. The ultrasonic energy can be applied to the slurry for a time period sufficient to break up or reduce the amount of agglomerates, for instance, for a time period ranging from about 30 seconds to about 1 hour, such as from about 1 minute to about 30 minutes, from about 2 minutes to about 20 minutes, from about 3 minutes to about 10 minutes, or from about 4 minutes to about 5 minutes, including all ranges and subranges therebetween. It is within the ability of one skilled in the art to select an ultrasonic frequency and/or time to achieve the desired result for a particular application.

The slurry thus prepared can be combined with the glass batch materials using any means known in the art to form a batch composition. In some embodiments, the slurry may be constantly stirred or agitated until just prior to addition to the glass batch materials, e.g., to prevent settling of the slurry and/or clogging of the pre-mixing vessel. The slurry can be, for example, pumped or otherwise transported from the pre-mixing vessel to the mixing vessel comprising the glass batch materials. Simple addition of the slurry to the glass batch materials can be carried out by pumping the slurry from the pre-mixing vessel into the mixing vessel. In various embodiments, the slurry can be sprayed or otherwise dispersed onto the glass batch materials. According to one non-limiting embodiments, the slurry can be spray dried onto the glass batch materials.

The batch composition can comprise, in various embodiments, from about 0.05% to about 1% by weight of fining agent (e.g., SnO₂), such as from about 0.15% to about 0.9% by weight, from about 0.2% to about 0.8%, from about 0.25% to about 0.7%, from about 0.3% to about 0.6%, or from about 0.4% to about 0.5% by weight, including all ranges or subranges therebetween. The batch composition can also comprise, in certain embodiments, from about 0.1% to about 5% by weight of at least one solvent, such as water, for example, from about 0.3% to about 4%, from about 0.5% to about 3%, or from about 1% to about 2% by weight of at least one solvent, including all ranges and subranges therebetween.

Addition of the slurry can occur with or without simultaneous mixing of the glass batch materials. In some embodiments, the slurry can be added to the glass batch materials as they are being mixed and without interruption in the mixing. In additional embodiments, after addition of the slurry to the glass batch materials the batch composition can be mixed for a time period that can vary, e.g., depending on the batch materials, concentration, tank size, and so forth. Mixing can be carried out, for instance, until uniform distribution of the fining agent in the batch composition is achieved, but before significant evaporation of the moisture from the slurry occurs, which can increase the risk of re-agglomeration of the fining agent (e.g., SnO₂) particles. According to some embodiments, the mixing time can range, for example, from about 1 minute to about 1 hour, such as from about 2 minutes to about 45 minutes, from about 3 minutes to about 30 minutes, from about 4 minutes to about 15 minutes, or from about 5 minutes to about 10 minutes, including all ranges and subranges therebetween.

The term “glass batch materials” and variations thereof is used herein to denote a mixture of glass precursor particles which, upon melting, react and/or combine to form a glass. The glass batch materials may be prepared and/or mixed by any known method for combining the glass precursor particles. For example, in certain non-limiting embodiments, the glass batch materials may comprise a dry or substantially dry mixture of glass precursor particles, e.g., without any solvent or liquid. In other embodiments, the glass batch materials may also be in the form of a slurry, for example, a mixture of glass precursor particles in the presence of a liquid or solvent.

According to various embodiments, the glass batch materials may comprise glass precursor materials, such as silica, alumina, and various additional oxides, such as barium, boron, magnesium, calcium, sodium, strontium, or titanium oxides. For instance, the glass batch materials may be a mixture of silica and/or alumina with one or more additional oxides. In various embodiments, the glass batch materials can comprise from about 30 to about 95 wt % collectively of alumina and/or silica and from about 5 to about 70 wt % collectively of at least one oxide of barium, boron, magnesium, calcium, sodium, strontium, tin, and/or titanium. The silica and/or alumina may be present in a combined amount of at least about 30 wt % of the glass batch materials, for instance, at least about 35 wt %, at least about 40 wt %, at least about 45 wt %, at least about 50 wt %, at least about 55 wt %, at least about 60 wt %, at least about 65 wt %, at least about 70 wt %, at least about 75 wt %, at least about 80 wt %, at least about 85 wt %, at least about 90 wt %, or at least about 95 wt %. According to certain embodiments, the glass batch materials may comprise from about 10 to about 50 wt % of silica. In other embodiments, the glass batch materials may comprise from about 10 to about 50 wt % of alumina. It is to be understood that mixtures of silica and alumina in the amounts indicated above may also be used.

The glass batch materials may be prepared by any method known in the art for mixing and/or processing glass batch materials. For instance, the batch materials may be mixed, milled, ground, and/or otherwise processed to produce a desired mixture with a desired size and/or shape. For example, the glass batch materials may have an average particle size of less than about 1,000 microns, for instance, less than about 900, 800, 700, 600, 500, 400, 300, 200, or 100 microns, and all ranges and sub-ranges therebetween. In various embodiments, the glass batch materials can have an average particle size ranging from about 5 microns to about 1,000 microns, such as from about 50 microns to about 900 microns, from about 100 microns to about 800 microns, from about 150 microns to about 700 microns, from about 200 microns to about 600 microns, or from about 250 microns to 500 microns, and all ranges and sub-ranges therebetween. In further embodiments, the average particle size of the glass batch materials may be less than about 100 microns, such as less than about 50 microns, less than about 25 microns, or less than about 10 microns.

After mixing, the batch composition can be melted according to any known method and using any equipment known in the art. For example, the batch composition can be added to a melting vessel and heated to a temperature ranging from about 1100° C. to about 1700° C., such as from about 1200° C. to about 1650° C., from about 1250° C. to about 1600° C., from about 1300° C. to about 1550° C., from about 1350° C. to about 1500° C., or from about 1400° C. to about 1450° C., including all ranges and subranges therebetween. The batch composition may, in certain embodiments, have a residence time in the melting vessel ranging from several minutes to several hours, depending on various variables, such as the operating temperature and the batch size. For example, the residence time may range from about 30 minutes to about 8 hours, from about 1 hour to about 6 hours, from about 2 hours to about 5 hours, or from about 3 hours to about 4 hours, including all ranges and subranges therebetween.

The molten glass can subsequently undergo various additional processing steps, including fining to remove bubbles, and stirring to homogenize the glass melt, to name a few. The molten glass can then be processed, e.g., by fusion-draw, slot-draw, or float processes to produce a glass ribbon or any other glass shape. According to various embodiments, the methods and systems described herein provide a means to melt and fine glass batch materials which can then be used to form glass structures. As used herein the term “glass structure” and variations thereof is intended to denote a glass article made by processing molten glass, for instance, any article produced after the melting and/or fining process. The glass structure is not limited in shape, dimension, composition, or microstructure, and can be any conventional or unconventional article. The glass structure can be, for example, an article that has been cooled, e.g., to room temperature, or can be an article that exists in a molten or semi-molten state. In some embodiments, the glass structure may be a glass sheet, such as that produced by fusion-draw, slot-draw, or float processes. A wide variety of other glass shapes with varying compositional and physical properties are envisioned and intended to fall within the scope of the disclosure.

The methods disclosed herein may have various advantages over prior art glass manufacturing methods. For instance, the reduction or elimination of agglomerates in the batch composition, which can result in solid defects in the ultimate glass product, can produce a significant cost savings, such as 1-2% OEE improvement per system. Moreover, the effectiveness of the fining agent can be increased if more of the fining agent is dispersed throughout the glass melt for fining as opposed to agglomerating into a solid defect. The improved fining effectiveness can result in an incremental reduction of gaseous inclusions without increasing the number of solid inclusions and/or without negatively impacting the product quality and/or OEE.

As compared to the liquid addition of sodium or potassium stannate, the material cost for dry or powdered fining agents is relatively lower, thereby resulting in a potential cost savings. Moreover, the slurry addition enables higher solid loading and lower liquid addition to the batch composition, which can decrease wear on the manufacturing system and/or potential glass product defects. Finally, the use of sodium or potassium stannate results in a glass product that necessarily comprises sodium or potassium, which may not be feasible for the production of certain glasses, e.g., sodium-free or potassium-free glasses.

Systems

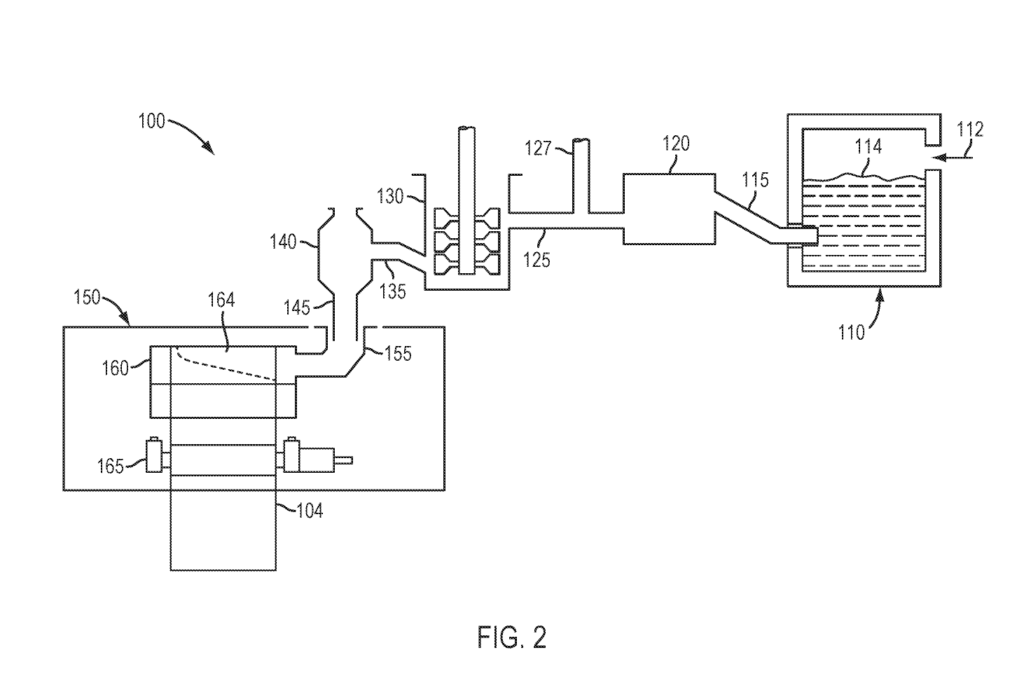

Embodiments of the disclosure will be discussed with reference to FIG. 2, which depicts an exemplary glass manufacturing system 100 for producing a glass ribbon 104. The glass manufacturing system 100 can include a melting vessel 110, a melting to fining tube 115, a fining vessel (e.g., finer tube) 120, a fining to stir chamber connecting tube 125 (with a level probe stand pipe 127 extending therefrom), a stir chamber (e.g., mixing vessel) 130, a stir chamber to bowl connecting tube 135, a bowl (e.g., delivery vessel) 140, a downcomer 145, and a fusion draw machine (FDM)150, which can include an inlet 155, a forming body (e.g., isopipe) 160, and a pull roll assembly 165.

A batch composition comprising glass batch materials can be introduced into the melting vessel 110, as shown by arrow 112, to form molten glass 114. The fining vessel 120 is connected to the melting vessel 110 by the melting to fining tube 115. The fining vessel 120 can have a high temperature processing area that receives the molten glass from the melting vessel 110 and which can remove bubbles from the molten glass. The fining vessel 120 is connected to the stir chamber 130 by the fining to stir chamber connecting tube 125. The stir chamber 130 is connected to the bowl 140 by the stir chamber to bowl connecting tube 135. The bowl 140 can deliver the molten glass through the downcomer 145 into the FDM 150.

The FDM 150 can include an inlet 155, a forming body 160, and a pull roll assembly 165. The inlet 155 can receive the molten glass from the downcomer 145, from which it can flow to the forming body apparatus 160, where it is formed into a glass ribbon 104. The pull roll assembly 165 can deliver the drawn glass ribbon 104 for further processing by additional optional apparatuses. For example, the glass ribbon can be further processed by a traveling anvil machine (TAM), which can include a mechanical scoring device for scoring the glass ribbon. The scored glass can then be separated into pieces of glass sheet, machined, polished, chemically strengthened, and/or otherwise surface treated, e.g., etched, using various methods and devices known in the art. Of course, the glass manufacturing system illustrated in FIG. 2 is exemplary only and provided herewith solely for the purpose of discussion. Other systems, e.g., systems not including a fusion draw machine, such as systems employing slot-draw or float processing, can be used and are envisioned as falling within the scope of the disclosure.

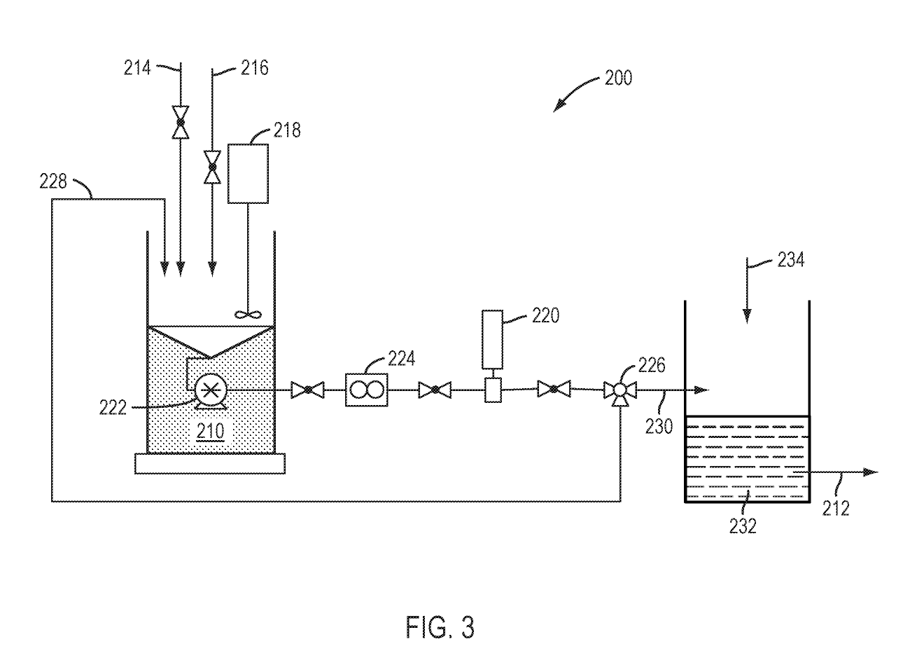

The systems disclosed herein can comprise a pre-mixing vessel for preparing a slurry comprising at least one fining agent; an ultrasonic vessel for applying ultrasonic energy to the slurry; a mixing vessel for combining the slurry with glass batch materials to form a batch composition; and a melting vessel for melting the batch composition. FIG. 3 depicts a schematic of an exemplary pre-mixing system 200 that can be used to provide a slurry as disclosed herein for addition to the glass batch materials to form a batch composition. The system 200 can include a pre-mixing vessel 210, in which a fining agent (not shown) and at least one solvent 214 can be combined to form a slurry. In certain embodiments, at least one buffer 216 can be added to the pre-mixing vessel 210. For example, the pre-mixing vessel can comprise a pH sensor (not shown) and a pH adjusting component (not shown) for adding the at least one buffer to the pre-mixing vessel 210. Mechanical agitation can be provided, e.g., using a mixer 218. The slurry can be transferred from the pre-mixing vessel via tubes or pipes, e.g., process piping (not shown).

Countermeasures for preventing or reducing material build up or clogging of the piping can be employed, for instance, flow rate adjustment, recirculation loops, and/or a system flushing cycle.

Ultrasonic energy can be applied to the slurry using an ultrasonicator 220. In certain embodiments, the ultrasonicator 220 can comprise a continuous flow cell coupled with a feed pump 222. However, the ultrasonicator 220 can also be configured for batch or semi-batch processing. According to additional embodiments, an optional mass flow meter 224 can be used to deliver a predetermined amount of SnO₂ to the mixing vessel. The mass flow meter 224 can provide real-time feedback to a process control system (not shown) which can allow the system to compensate for variations in the slurry concentration. An optional recycle valve 226 can be used to recirculate a portion of the slurry back to the pre-mixing vessel in a recycle loop 228. The remaining portion of the slurry 230 can be delivered to the mixing vessel 232 to be combined with the glass batch materials 234 to form a batch composition. The batch composition 212 thus formed can then proceed to the melting vessel as depicted in FIG. 2.

It will be appreciated that the various disclosed embodiments may involve particular features, elements or steps that are described in connection with that particular embodiment. It will further be appreciated that a particular feature, element or step, although described in relation to one particular embodiment, may be interchanged or combined with alternate embodiments in various non-illustrated combinations or permutations.

It is to be understood that, as used herein the terms “the,” “a,” or “an,” mean “at least one,” and should not be limited to “only one” unless explicitly indicated to the contrary. Thus, for example, reference to “an additive” includes examples having two or more such “additives” unless the context clearly indicates otherwise.

Ranges can be expressed herein as from “about” one particular value, and/or to “about” another particular value. When such a range is expressed, examples include from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

Various ranges are expressed herein as “greater than about” one or more particular values or “less than about” one or more particular values and “all ranges and subranges therebetween.” When such ranges are expressed, examples include from any one particular value to any other particular value, and all other possible ranges between each disclosed value.

All numerical values expressed herein are to be interpreted as including “about,” whether or not so stated, unless expressly indicated otherwise. It is further understood, however, that each numerical value recited is precisely contemplated as well, regardless of whether it is expressed as “about” that value. Thus, “a temperature greater than 1000° C.” and “a temperature greater than about 1000° C.” both include embodiments of “a temperature greater than about 1000° C.” as well as “a temperature greater than 1000° C.”

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred.

While various features, elements or steps of particular embodiments may be disclosed using the transitional phrase “comprising,” it is to be understood that alternative embodiments, including those that may be described using the transitional phrases “consisting” or “consisting essentially of,” are implied. Thus, for example, implied alternative embodiments to a method comprising A+B+C include embodiments where the method consists of A+B+C, and embodiments where the method consists essentially of A+B+C.

It will be apparent to those skilled in the art that various modifications and variations can be made to the present invention without departing from the spirit and scope of the invention. Since modifications combinations, sub-combinations and variations of the disclosed embodiments incorporating the spirit and substance of the invention may occur to persons skilled in the art, the invention should be construed to include everything within the scope of the appended claims and their equivalents.

The following Examples are intended to be non-restrictive and illustrative only, with the scope of the invention being defined by the claims.

### EXAMPLES

Slurries were prepared by mixing tin dioxide (from Oximet via Endeka, OTO Extra-E, Sassuolo, Modena, Italy) with deionized (DI) water at a concentration of 25 wt % SnO₂. Slurry A was pH adjusted using nitric acid (pH=3). Slurry B was not pH adjusted (pH=6). Composition C (comparative) comprising sodium stannate (11.9 wt % SnO₂) was used as a reference. Each slurry/composition was sprayed onto dry glass batch materials to yield a batch composition comprising 0.15% by weight of SnO₂. A static melt assessment for solid defects was performed. Without mixing the batch compositions, tin dioxide aggregates formed and hardened for all compositions. Mixing and subsequent melting of the batch compositions provided results for slurries A and B that were similar when compared to composition C. A notable difference between slurries A and B (with and without pH adjustment) was not observed.

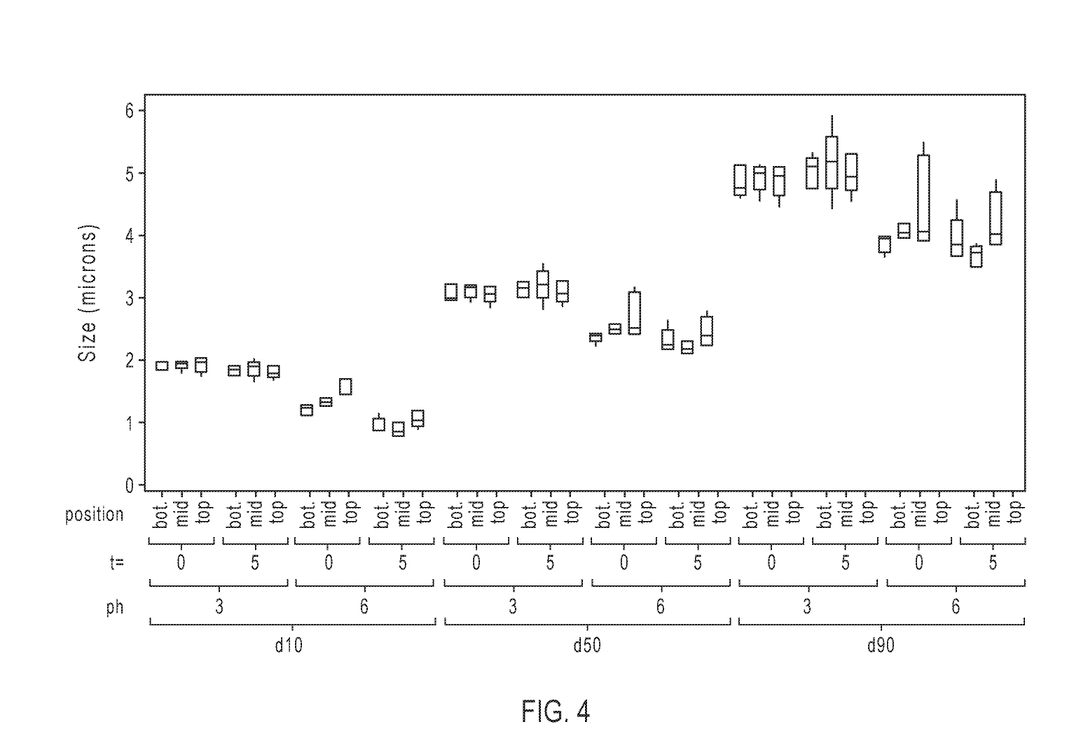

Slurries A and B were subjected to ultrasonication (20 kHz, 5 hours) and then analyzed for particle size distribution using a Microtrac S3500 laser diffraction particle size analyzer. FIG. 4 is a graphical depiction of the particle size distributions (d₁₀, d₅₀, d₉₀) for slurries A and B (pH=3, 6, respectively) with and without ultrasonication (t=0, 5, respectively). Samples were drawn from different locations in the mixing vessel (bottom, top, middle) for improved accuracy. As can be seen in the box plot, in the absence of pH adjustment, a dependency exists between sampling location and measurement time for particle size. However, for pH modified samples, there does not appear to be a dependency between these factors and particle size, therefore suggesting greater overall homogeneity and suspension stability.

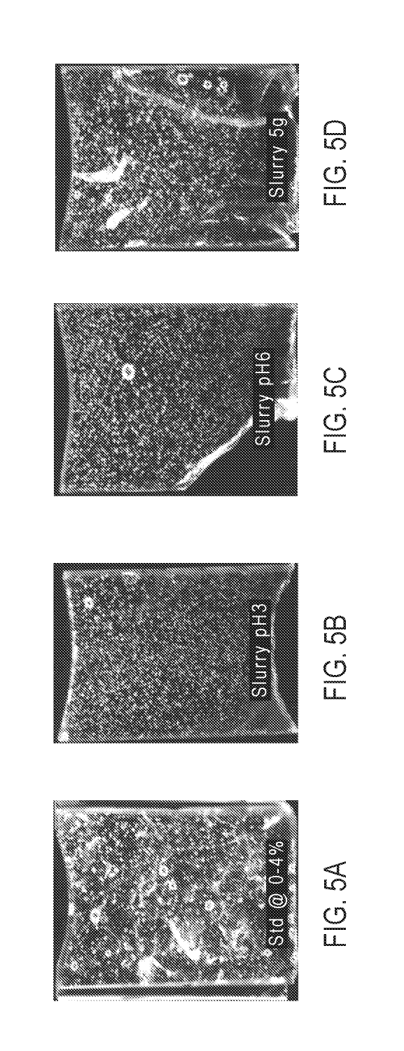

FIGS. 5A-D are images of glass melts prepared with dry tin dioxide powder addition sufficient for a target concentration of 0.15 wt % SnO₂ (FIG. 5A), with slurry A (FIG. 5B), with slurry B (FIG. 5C), and with composition C (FIG. 5D). As can be appreciated from the images, the glass melt prepared with dry tin dioxide addition exhibited seven TOAs (200-1500 nm). In contrast, the glass melts made using slurries A and B exhibited no TOAs, as did the glass melt made using comparative composition C. All compositions exhibited some minor degree of silica and seeds.

1. A method for making glass, comprising:
forming a slurry comprising at least 15% by weight of at least one fining agent;
adjusting the pH of the slurry to a value ranging from 3 to 12;
combining the slurry with glass batch materials to form a batch composition; and
melting the batch composition.

2. The method of claim 1, wherein forming the slurry comprises combining at least one fining agent having an average particle size ranging from about 2 to about 10 microns with at least one solvent.

3. The method of claim 1, wherein the at least one fining agent is chosen from SnO₂, As₂O₃, Sb₂O₃, and combinations thereof.

4. The method of claim 2, wherein the solvent is water.

5. The method of claim 1, further comprising applying mechanical energy, ultrasonic energy, or a combination thereof to the slurry.

6. The method of claim 5, wherein the ultrasonic energy has a frequency ranging from about 5 kHz to about 50 kHz.

7. The method of claim 1, wherein the pH of the slurry is adjusted by adding at least one buffer chosen from hydrochloric acid, sulfuric acid, nitric acid, acetic acid, propionic acid, aqueous ammonia, sodium hydroxide, organic amines, and combinations thereof.

8. The method of claim 1, wherein the zeta potential of the slurry ranges from about +5 mV to about +60 mV or from about −5 mV to about −60 mV.

9. The method of claim 1, wherein the slurry comprises from about 15% to about 35% by weight of SnO₂.

10. A method for reducing agglomerates in a glass melt, the method comprising:
forming a slurry comprising at least one fining agent having an average particle size ranging from about 2 microns to about 10 microns;
adjusting the pH of the slurry to a value ranging from 3 to 12;
combining the slurry with glass batch materials to form a batch composition; and
melting the batch composition.

11. The method of claim 10, wherein the slurry comprises at least 15% by weight of the at least one fining agent.

12. The method of claim 10, wherein the at least one fining agent comprises SnO₂, As₂O₃, Sb₂O₃, or combinations thereof.

13. The method of claim 10, wherein the pH of the slurry is adjusted by adding at least one buffer chosen from hydrochloric acid, sulfuric acid, nitric acid, acetic acid, propionic acid, aqueous ammonia, sodium hydroxide, organic amines, and combinations thereof.

14. The method of claim 10, wherein the zeta potential of the slurry ranges from about +5 mV to about +60 mV or from about −5 mV to about −60 mV.

15. The method of claim 10, further comprising forming the slurry by combining the at least one fining agent with at least one solvent.

16. The method of claim 10, further comprising application to the slurry of mechanical energy, ultrasonic energy, or a combination thereof.

17. A system for making glass, comprising:
a pre-mixing vessel for preparing a slurry comprising at least one fining agent;
an ultrasonic vessel for applying ultrasonic energy to the slurry;
a mixing vessel for combining the slurry with glass batch materials to form a batch composition; and
a melting vessel for melting the batch composition.

18. The system of claim 17, further comprising a pH adjusting component for adding at least one buffer to the slurry, and at least one pH sensor for measuring the pH of the slurry.

19. The system of claim 17, further comprising a mass flow meter for measuring the amount of the at least one fining agent in the slurry prior to combination with the glass batch materials, and optionally at least one control system for adjusting a flow rate of the slurry.

20. The system of claim 17, wherein the slurry comprises at least 15% by weight of at least one fining agent chosen from SnO₂, As₂O₃, Sb₂O₃, and combinations thereof, and having an average particle size ranging from about 2 microns to about 10 microns.

21. The system of claim 17, wherein the ultrasonic energy has a frequency ranging from about 5 kHz to about 50 kHz.

22. A method for making glass, comprising:
combining a slurry comprising at least one fining agent with glass batch materials to form a batch composition; and
melting the batch composition;
wherein the slurry has a pH ranging from 3 to 12; and
wherein the zeta potential of the slurry ranges from +5 mV to +60 mV or from −5 mV to −60 mV.

23. The method of claim 22, wherein the slurry comprises at least 15% by weight of the at least one fining agent.

24. The method of claim 22, wherein the at least one fining agent has a particle size ranging from about 2 microns to about 10 microns.

25. The method of claim 22, further comprising forming the slurry by combining the at least one fining agent with at least one solvent and applying mechanical energy, ultrasonic energy, or a combination thereof to the slurry.

26. The method of claim 22, wherein the at least one fining agent is chosen from SnO₂, As₂O₃, Sb₂O₃, and combinations thereof.
